(19) United States
(12) Patent Application Publication
(10) Pub. No.: US 2008/0146397 A1
(43) Pub. Date: Jun. 19, 2008

(54) Dual output gear motor

(76) Inventor: Frank Drake, Wausau, WI (US)

Correspondence Address: MCDONALD HOPKINS LLC, 600 Superior Avenue, East, Suite 2100, CLEVELAND, OH, 44114-2653, US

(21) Appl. No.: 11/641,469

(22) Filed: Dec. 18, 2006

(51) Int. Cl. B60S 9/02

(52) U.S. Cl. 475/206; 254/418

(57) ABSTRACT

A motorized jack assembly that is used with trailers that has a functional combination of several outputs providing different speeds for raising or lowering the jack. The jack has a drop leg feature to allow for quickly raising or lowering the jack. The motorized jack assembly has an actuator having a motor integrated with a gearbox that not only has the capacity to handle a relatively heavy load, but also have the ability to handle small and midsize loads at efficient speeds. The jack has a cover for protecting the actuator and providing user friendly controls for operating the actuator and the jack.

### FIELD AND BACKGROUND OF THE INVENTION

This invention generally relates to a motorized jack, and more particularly, to a motorized jack assembly having at least two outputs for raising or lowering a jack.

Typically, jacks operate mechanically to raise or lower objects, such as, trailers. Jacks operating mechanically require a user to turn a crank a shaft to raise or lower the object connected to the jack, such as, a trailer. Operating the crank to raise or lower the object is not only time-consuming but also inconvenient and rigorous. As a result, there is a need for a motorized jack having lifting and lowering capabilities, ease of cranking and overall performance for both loaded and unloaded trailers.

It is generally known to couple a motor to a gearbox to power a jack. However, such motors operate at one speed and cannot operate multiple jacks. Coupling the motor to the gearbox of mechanically operated jacks requires an additional gearbox. Therefore, a need exists for a motorized jack that eliminates the additional gearbox and provides easy and convenient connection to jacks. In addition, a need exists for a motorized jack having multiple output speeds.

In many instances, it is desirable to have a jack that moves upward or downward at a high rate of speed when, for example, the jack is not in contact with the object to raise or lower. For example, the jack may require raising to a height to contact the trailer before raising the trailer. In such instances, there is a need for a jack operating at a high rate of speed prior to contacting the trailer. In addition, there is a need for a jack operating at a high torque as the jack begins to raise the trailer.

In addition, it is oftentimes desirable to quickly provide elongation of the jack, such as in a drop leg, where there is not any mechanical cranking required in order to have a significant amount of jack elongation or contraction in a short amount of time, such as at the beginning or completion of the lifting process.

Moreover, the drop leg of the jack can frequently contact the ground such that the trailer will be raised unevenly. In other words, the drop leg may abut the ground to raise one side of the trailer more than the opposite side of the trailer. Therefore, it would be advantageous to provide a jack having a level to ensure proper alignment of the jack prior to and during raising or lowering of the object, such as the trailer.

Operating a jack at night or in a dark environment is difficult. For example, the drop leg of the jack may contact an object on the ground that the user is unable to see. Additionally, it is often difficult to operate the drop leg of the jack as well as other components of the jack in dark environments. Accordingly, it would be advantageous to incorporate lighting within the jack assembly.

The present invention overcomes the deficiencies of the prior art by providing an actuator connectable to a jack that has two output speeds, an integrated motor and gearbox, lighting and a level. Other advantages of the present invention will be appreciate by one of ordinary skill in the art.

### BRIEF SUMMARY OF THE INVENTION

Disclosed herein is an actuator for use with a jack, such as a trailer jack. The actuator integrates a motor and a gearbox and provides at least two outputs. The first output operates at a first rate of speed providing a corresponding first amount of torque. The second output operates at a second rate of speed providing a second amount of torque. The first rate of speed is higher than the second rate of speed and the first amount of torque is less than the second amount of torque. As a result, the motorized jack efficiently and conveniently provides at least two different output speeds and at least two different amounts of torque. Advantageously, the jack can utilize a lower amount of torque before contacting a trailer and a higher amount of torque when raising the trailer. In addition, the actuator can connect to two jacks for raising or lowering, for example, landing gear of a trailer.

### BRIEF DESCRIPTION OF THE DRAWINGS

The drawings illustrate the best mode presently contemplated for carrying out the invention. In the drawings:

FIG. 1 illustrates a perspective view of an actuator having a first output and a second output for selectable connection to a jack to raise or lower the jack in accordance with one aspect of the present invention.

FIG. 2 illustrates a perspective view of an actuator connected to a shaft of a jack in an embodiment of the present invention.

FIG. 3 is a side view of a jack having a drop leg connected to an actuator in an embodiment of the present invention.

FIG. 4 is a perspective view of an actuator connected to a first jack and a second jack in an embodiment of the present invention.

FIG. 5 is a perspective view of a first jack connected to a first actuator and a second jack connected to a second actuator in an embodiment of the present invention.

FIG. 6A illustrates an actuator connected to a jack in an alternate orientation in an embodiment of the present invention.

FIG. 6B illustrates the actuator of FIG. 6A having a cover in an embodiment of the present invention.

### DETAILED DESCRIPTION OF THE INVENTION

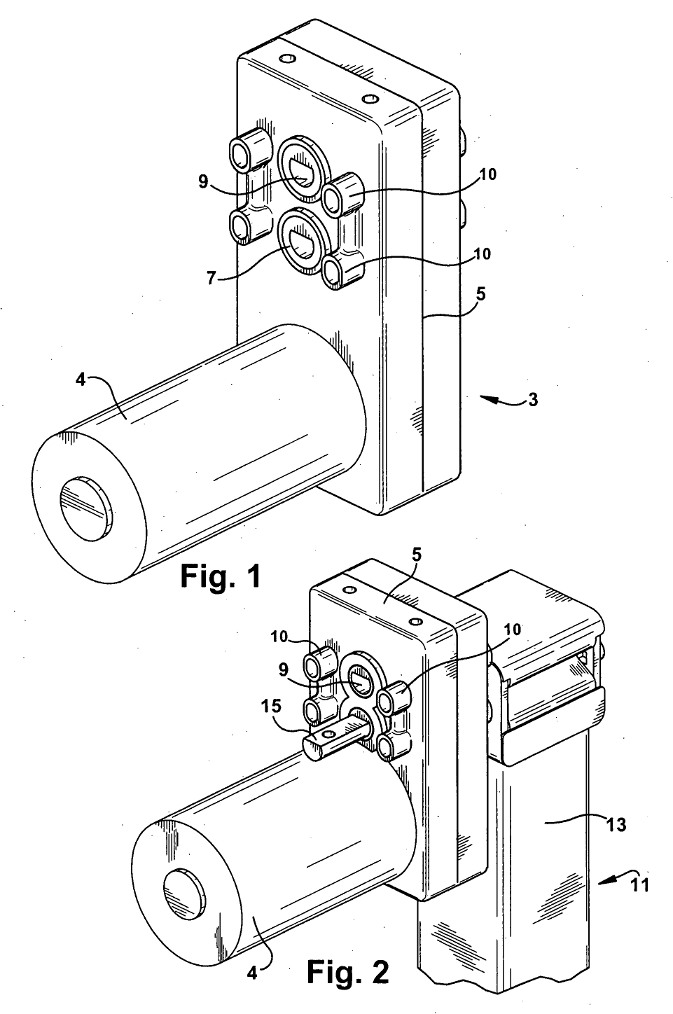

Referring to FIG. 1, a perspective view of an actuator 3 for a jack in an embodiment of the present invention. In an exemplary embodiment, a motor 4 and a gearbox 5 are integrated in the actuator 3 such that coupling a motor to a gearbox is eliminated. The motor 4 provides input power to gearing within the gearbox 5 to output torque. The motor 4 eliminates the need for human effort to input power to the jack. In an exemplary embodiment, the motor 4 is electrically powered.

The actuator 3 has a first output 7 and a second output 9. The outputs 7, 9 are connectable to a shaft, such as, an axle of a trailer jack. In such an embodiment, the outputs 7, 9 rotate the shaft to raise or to lower the jack. A trailer may be raised or lowered by connection of the jack to the trailer. Trailers that are contemplated for use with the present invention include, but are not limited to, RV trailers, horse trailers, livestock trailers, a-frame trailer, large flatbed trailers, and construction equipment trailers. For example, the actuator 3 operates to raise or lower a jack of a RV trailer or to raise or lower an a-frame of a RV trailer.

The first output 7 operates at a first rate of speed and provides a first amount of torque. The second output 9 operates at a second rate of speed and provides a second amount of torque. In a preferred embodiment, the first rate of speed is greater than the second rate of speed and the first amount of torque is less than the second amount of torque. In a most preferred embodiment, the first rate of speed is twice that of the second rate of speed and the first amount of torque is one-half of the second amount of torque. The low gear speed at the second output 9 facilitates lifting of relatively higher loads, and the working high gear speed at the first output 7 facilitates faster lifting of relatively lower and medium-sized loads or lowering relatively high loads. The actuator 3 provides different amounts of torque and different output speeds to the outputs 7, 9 due to different gear ratios of the gearing of the actuator 3. The gear ratio is changed by selectably connecting the actuator 3 at the output 7 or the output 9.

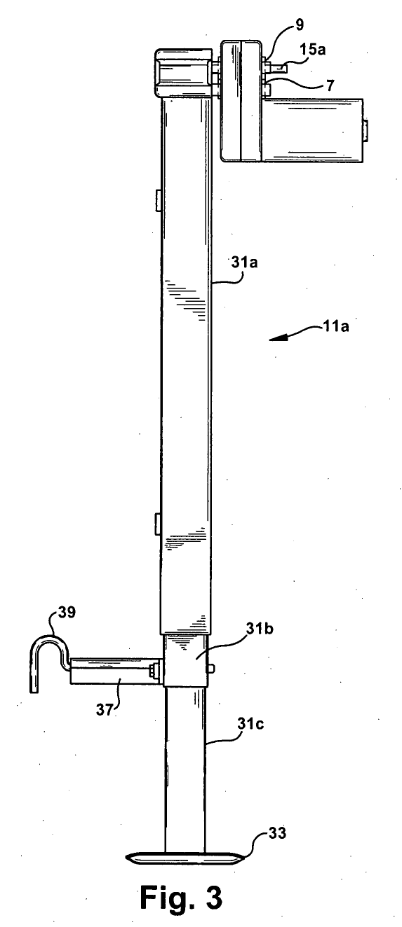

The actuator 3 has apertures 10 in the gearbox 5 for mounting the actuator 3 to a jack 11. As illustrated in FIGS. 2 and 3, the actuator 3 is mountable to the jack 11, such as, an upper housing section 13 of the jack 11. Preferably, the actuator 3 is mounted on the jack at or adjacent to a drive mechanism of the jack 11. The drive mechanism causes telescopic movement of the jack 11 by moving the upper housing section 13 of the jack 11 with respect to a lower section 15 of the jack 11.

An axle or shaft 15 is typically connected to the drive mechanism of the jack 11. For example, the shaft 15 engages the drive mechanism to cause telescopic movement of the jack 11. The outputs 7, 9 are selectably connectable to the shaft 15 to impart rotational torque as well as translation to the jack 11. In a preferred embodiment, one of the outputs 7, 9 of the actuator 3 is selectably connected to the shaft 15 to raise or lower the jack. For example, the actuator 3 is positioned such that the first output 7 engages the shaft 15 of the jack 11. At such a position, the jack 1I may raise at a high rate of speed relative to the second output 9. The actuator 3 may be removed when the jack 11 is raised to a position contacting the trailer. The actuator 3 may then be positioned such that the second output 9 engages the shaft 11 to raise the jack 11 and the trailer. The second output 9 may rotate the shaft 15 at a lower rate of speed but provide more torque relative to the first output 7 to raise the trailer.

Turning to FIG. 3, a perspective view of the actuator 3 connected to a jack 11a in an embodiment of the present invention is illustrated. The jack 11a has tubular sections 31a, 31b and 31c. Each tubular section 31a-31c is telescopically movable to raise or to lower the jack 11a. Rotation of shaft 15a translates into linear movement of jack 11a, and more particular, the tubular section 31a relative to the tubular section 31b, in order to raise and lower the jack 11a. The tubular section 31c may be utilized as, for example, a drop leg to move the jack 11a quickly between a retracted position and an extended position in which base 33 of the jack 11a is in close proximity to the ground. The drop leg is in sliding, telescoping relationship with tubular section 31b. The tubular sections 31a-31c are supported by the base 33 of the jack 11.

The tubular section 31b includes a pin assembly 37 having a pin 39 used to secure the drop leg into position relative to the tubular section 31b. The drop leg may be utilized to move the base to quickly provide elongation or contraction of jack elongation in a short amount of time, such as at the beginning or completion of the lifting process. In such an embodiment, the drop leg provides the through-the-air function. As a result, the outputs 7, 9 do not have to provide a high speed of rotation of the shaft 15a to raise the jack 11a to satisfy the through-the-air function.

With incorporation of the drop leg, each of the outputs 7, 9 can be utilized for lifting loads of the jack 11a and neither output is required to operate at a high speed that cannot carry a load. The outputs 7, 9 can be operator selected to lift various loads with as much speed as possible. For example, one of the outputs 7, 9 can operate at a higher speed (and lower torque) for relatively light loads on the jack 11a. Likewise, one of the outputs 7, 9 can operate at a lower speed (and higher torque) for relatively heavier loads on the jack 11a. In an exemplary embodiment, one of the outputs 7, 9 can be used to raise or lower two jacks, such as, landing gear of a trailer. Therefore, the overall efficiency of the jack 11a increases by reducing time required to raise and lower the jack 11a for more than one loading condition.

The two outputs 7, 9 plus drop leg embodiment is particularly desired when the loads change from fully loaded to unloaded, and where loading and unloading occurs frequently, such as in vehicle or animal trailers. The outputs 7, 9 can serves as a working high gear and a working low gear each having a turns per inch (TPI) parameter selected at least in part to complement the drop leg. By “complement” it is meant that the TPI parameters are selected based on the anticipation of the availability of the drop leg.

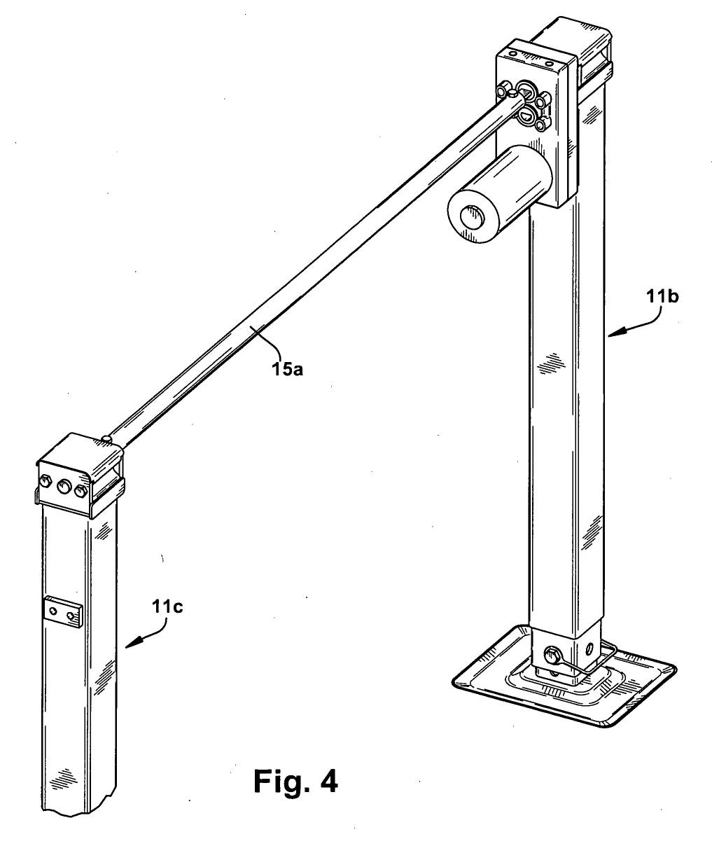

In another embodiment of the present invention as illustrated in FIG. 4, the actuator 3 is selectably connected to a first jack 11b and a second jack 11c. The first jack 11b and the second jack 11c may be utilized as, for example, landing gear for a trailer, such as, an RV trailer. The actuator 3 is secured to a first jack 11a and connected via a shaft 15a to a second jack 11c. In an embodiment, the shaft 15a is a hex shaft connected to one of the outputs 7,9 and the second jack 11c. The outputs 7, 9 are selectably connected to the shaft 15a causing rotation of the shaft 15a and, in turn, raising or lowering of the first jack 11b and the second jack 11c. In such an embodiment, the output 7 may raise or lower the jacks 11b, 11c at a slow rate (with high torque) and the output 9 may raise or lower the jacks 11b, 11c at a higher rate (with lower torque). Depending on the size of the load to be raised or lowered by the jacks 11b, 11c, the output 9 may provide enough torque to raise or lower the jacks 11b, 11c. The drop leg may be incorporated into the jacks 11b, 11c. The rates of speed and amounts of torque provided by the outputs 7, 9 may be adjusted based on the presence or absence of the drop leg. In one such embodiment, the output 9 may be used to raise or lower the jacks 11b, 11c and the output 7 may be used to merely raise or lower one of the jacks 11b, 11c.

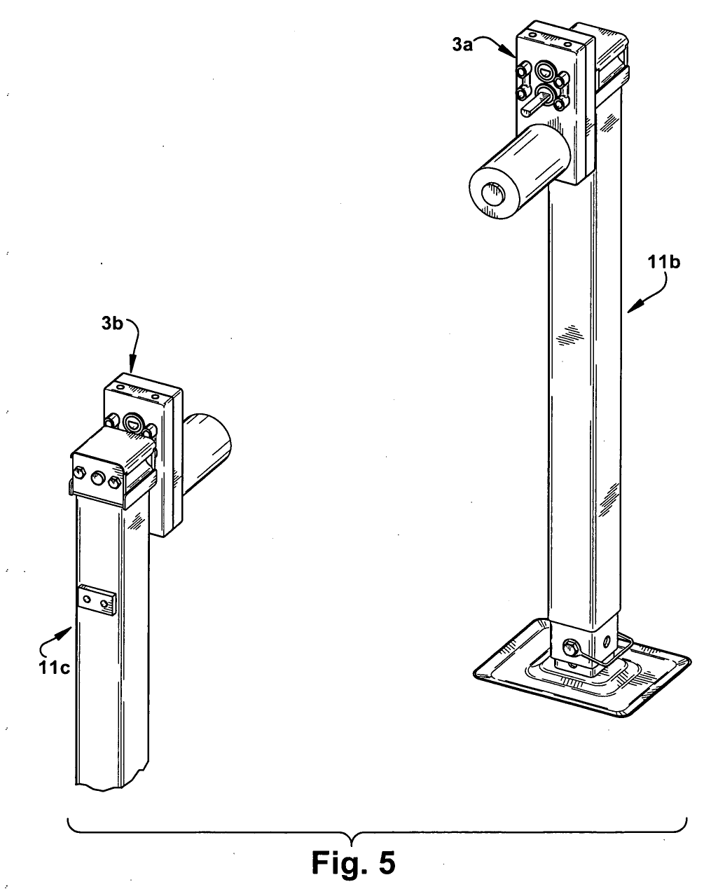

FIG. 5 illustrates an embodiment of the present invention having actuators 3a, 3b individually and independently raising and lowering the jacks 11b, 11c. The actuators 3a, 3b may utilize the outputs 9 to raise and lower the jacks 11b, 11c at a higher rate of speed. In this embodiment, the jacks 11b, 11c may not require a high amount of torque due to independent connection of the actuators 3a, 3b to each of the jacks 11b, 11c.

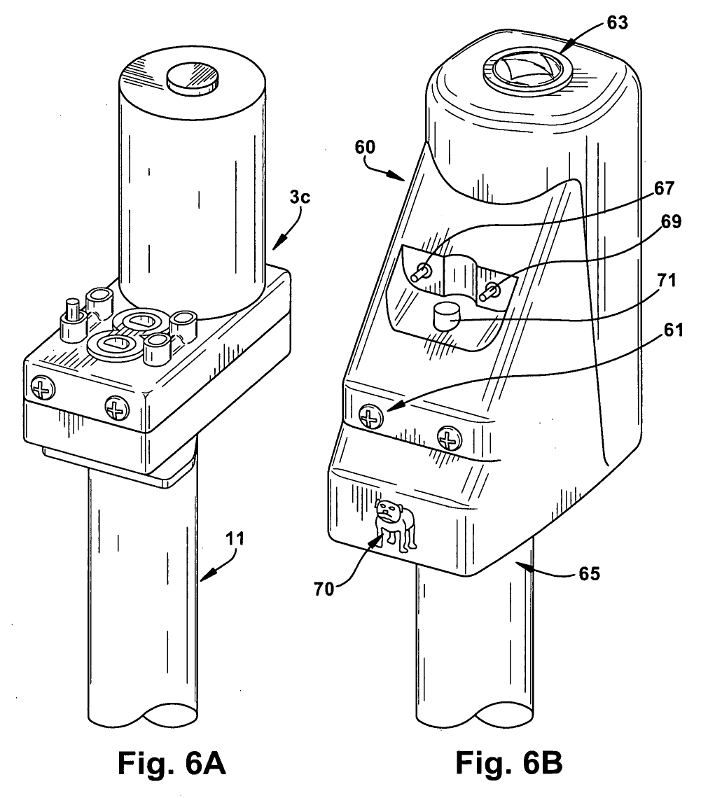

FIGS. 6A and 6B illustrate an embodiment of the actuator 3c orientated for use with, for example, an a-frame application. The actuator 3c may be used to raise and lower an a-frame attached to an RV trailer. The actuator 3c is rotated relative to the embodiments of the actuator 3 illustrated in FIGS. 4 and 5. In a typical a-frame application, for example, it may be advantageous to connect the actuator 3 at the top of the jack 11. The present invention should not be deemed as limited to a specific arrangement of connection of the actuator 3 to the jack 11. One of ordinary skill in the art will appreciate other arrangements of connection of the actuator 3 to the jack 11.

FIG. 6B illustrates a cover 60 attached to the actuator 3. The cover 60 may be made of plastic, rubber, metal or other protective material. The cover 60 may protect the actuator 3 from mechanical damage. Fasteners 61 may secure the cover 60 to the actuator 3 and/or the jack 11. A level 63 may be connected to and/or integrated into the cover 60. The level 63 may be, for example, a bubble level that indicates the position of the jack 11 relative to the horizon. In use, the level indicates the position of the jack 11 as the jack 11 raises or lowers relative to the ground. In a preferred embodiment, the level 63 is located at the top end of the cover 60. A user of the jack 11 may use the level 63 to adjust the position of the jack 11 as the jack 11 raises or lowers relative to the ground. In a most preferred embodiment, the user of the jack 11 utilizes the level 63 to establish a level position of the jack 11 prior to raising the object.

A light 65 is attached to the cover 60 such that the light 65 illuminates the area below the jack 11. The light 65 may be electrically connected to a light switch 67. To activate or deactivate the light 65 a user may engage the light switch 67. To this end, the light 65 illuminates the jack 11 and allows effective operation of the jack 11 in operation in dark environments.

A jack switch 69 is integrated and/or connected to the cover 60. The jack switch 69 is in communication with the actuator 3 to control power, such as electricity, from a power source to the actuator 3. In an embodiment, the jack switch 69 controls operation of the actuator 3 to raise and lower the jack 11. In another embodiment, the cover 60 has an emergency override control 71. In case of emergencies, such as, when it is desired to power down the jack 11, triggering the emergency override control 71 terminates power to the jack 11. In an embodiment, power supplied to the jack 11 is immediately stopped from reaching the actuator 3.

In another embodiment of the present invention, the cover 60 may display an emblem 70, such as the brand name, a logo and a symbol related to the jack I 1. The emblem 70 may be information, such as, information relating to the type of the jack 11 and the speeds and/or torque amounts of the outputs 7, 9 of the jack 11. The cover 60 is removably attached or secured to the actuator 3. FIG. 6B illustrates the cover 60 removed from the actuator 3 in an embodiment of the present invention.

The present invention has been described with respect to several embodiments. Equivalents, alternatives, and modifications, aside from those expressly stated herein, are possible and should be understood to be within the scope of the appending claims.

1. An actuator for raising or lowering a jack, the actuator comprising:
a gearbox;
a motor providing input power to the gearbox;
a first output and a second output independently selectably connected to the jack, wherein the input power from the motor translates into movement of the jack at the first output or the second output, and further wherein the first output raises or lowers the jack at a higher speed and a lower torque than the second output.

2. The actuator of claim 1 wherein the actuator is independently selectably connected to an axle of the jack at the first output or the second output.

3. The actuator of claim 1 wherein the speed of the first output is twice the speed of the second output.

4. The actuator of claim 1 wherein the first output and the second output are connectable to a second jack for raising or lowering the second jack.

5. The actuator of claim 1 further comprising:
a cover at least partially surrounding the actuator.

6. The acutator of claim 5 wherein the cover has a level for indicating a position of the jack relative to the horizon.

7. A jack assembly for raising and lowering an object, the jack assembly comprising:
a jack having a housing and a shaft extending from the housing, wherein the housing is connected to the object to be raised or lowered, wherein rotation of the shaft causes telescopic movement of the jack to raise or lower the object;
an acutuator connectable to the shaft, wherein the actuator has a first output and a second output, wherein each output is selecatably connectable to the shaft for causing rotation of the shaft and further wherein the actuator has a motorized gearbox for rotating the shaft to raise or lower the jack.

8. The jack assembly of claim 7 wherein the first output rotates the shaft at a speed greater than the second output.

9. The jack assembly of claim 8 wherein the first output provides less torque to the jack to raise the object than the torque provided by the second output.

10. The jack assembly of claim 7 wherein the first output and the second output are connectable to a second jack to raise or lower the second jack.

11. The jack assembly of claim 7 further comprising:
a drop leg telescopically moveable relative to the object to be raised or lowered by the jack and engageable therewith along a range of telescopic positions, the drop leg capable of engagement with the ground.

12. The jack assembly of claim 7 wherein said shaft is a non-round shaft.

13. The jack assembly of claim 7 further comprising:
a cover having a level for indicating a position of the jack relative to the horizon.

14. The jack assembly of claim 13 further comprising:
a light connected to the cover for illuminating a base of the jack.

15. An electrically powered jack assembly for raising and lowering an object, the electrically powered jack assembly comprising:
a jack having a first housing and a second housing wherein said first housing telescopically engages said second housing;
an actuator connected to the jack wherein the actuator causes telescopic movement of said first housing with respect to said second housing along a range of telescopic positions to raise or lower said object;
wherein the actuator has a motor having a first output and a second output;
a shaft engaging the actuator at the first output or the second output to raise or lower the jack, the first output transferring less torque to rotate the shaft than the second output.

16. The electrically powered jack assembly of claim 15 wherein the first output rotates the shaft at a higher speed than the second output.

17. The electrically powered jack assembly of claim 15 wherein said input shaft is connectable to a second jack for raising or lowering said object.

18. The electrically powered jack assembly of claim 15 wherein said input shaft is selectably connected to said first output or said second output.

19. The electrically powered jack assembly of claim 15 wherein the jack assembly is connectable to an a-frame style of a trailer to raise or lower the trailer.

20. The electrically powered jack assembly of claim 16 further comprising::
a cover substantially covering the actuator, the cover having a jack switch connected to the actuator for operating the actuator to raise or lower the jack.
